(19) United States
(12) Patent Application Publication
(10) Pub. No.: US 2010/0010804 A1
(43) Pub. Date: Jan. 14, 2010

(54) METHODS AND SYSTEMS FOR EXTRACTING PHENOTYPIC INFORMATION FROM THE LITERATURE VIA NATURAL LANGUAGE PROCESSING

(75) Inventors: Carol Friedman, New York, NY (US); Yves A. Lussier, Chicago, IL (US); Lyudmila Ena, Rego Park, NY (US)

Correspondence Address: BAKER BOTTS L.L.P., 30 ROCKEFELLER PLAZA, 44TH FLOOR, NEW YORK, NY, 10112-4498, US

(73) Assignee: THE TRUSTEES OF COLUMBIA UNIVERSITY IN THE CITY OF NEW YORK, New York, NY (US)

(21) Appl. No.: 12/498,898

(22) Filed: Jul. 7, 2009

Related U.S. Application Data
(63) Continuation of application No. PCT/US08/56220, filed on Mar. 7, 2008.
(60) Provisional application No. 60/894,062, filed on Mar. 9, 2007.

(51) Int. Cl. G06F 17/27

(52) U.S. Cl. 704/9

(57) ABSTRACT

Systems and methods for extracting and encoding genotype-phenotype information from journal articles and other publications are provided. In some embodiments, the disclosed subject matter includes a preprocessor, boundary identifier, parser, phrase recognizer and an encoder to convert natural-language input text and parameters into structured text. The structured text can take the form of codes which account for genotype-phenotype information and are compatible with a controlled vocabulary.

### CROSS REFERENCE TO RELATED APPLICATIONS

This application is a continuation of International Application PCT/US2008/056220, filed Mar. 7, 2008, which claims priority from U.S. Provisional Application Ser. No. 60/894,062, filed Mar. 9, 2007, each of which is incorporated by reference in its entirety herein.

### STATEMENT REGARDING FEDERALLY SPONSORED RESEARCH

This invention was made with government support under NIM/NLM grants 1K LM008303-01(YL) and R01 LM007659(CF), awarded by the National Institutes of Health. The government has certain rights in the invention.

### BACKGROUND

1. Technical Field

The present application relates to natural language processing (“NLP”), and more particularly, to the extraction and encoding of medical and clinical data from information found in journal articles and other publications.

2. Background Art

Techniques for processing certain types of biomedical documents are known. These existing techniques identify biomolecular entities, detect relations among biomolecular entities, and/or discover new knowledge by piecing together information from heterogeneous resources.

In the biological domain, it has recently been recognized that to achieve interoperability and improved comprehension, it is important for text processing systems to map extracted information to ontological concepts. For example, U.S. Pat. No. 6,182,029 to Friedman, discloses techniques for processing natural language medical and clinical data, commercially known as MedLEE. In one embodiment, a method is presented where natural language data is parsed into intermediate target semantic forms, regularized to group conceptually related words into a composite term (e.g., the words enlarged and heart may be brought together into one term, “enlarged heart”) and eliminate alternate forms of a term, and filtered to remove unwanted information. MedLEE differs from the other NLP coding systems in that the codes are shown with modified relations so that concepts may be associated with temporal, negation, uncertainty, degree, and descriptive information, which affects the underlying meaning and are critical for accurate retrieval of subsequent medical applications.

Although the techniques described in the '029 patent work well to process clinical documents, a technique is needed to process information obtained from medical and other literature which include complex genotypic and phenotypic terms. Accordingly, there exists a need for a technique for processing natural language data obtained from literature which include genotypic-phenotypic relations and their modifier.

### SUMMARY

Systems and methods for extracting and encoding genotype-phenotype relationships from information found in journal articles and other publications are disclosed herein.

In some embodiments, the disclosed subject matter includes a preprocessor, boundary identifier, parser, phrase recognizer and an encoder to convert natural-language input text and parameters into structured text. The structured text can take the form of codes which account for genotype-phenotype relations and are compatible with a controlled vocabulary.

The preprocessor receives natural-language input text and parameters, and outputs words where biological terms are tagged. In some embodiments of the disclosed subject matter, the preprocessor can extract relevant text, perform tagging so that irrelevant text is ignored, handle parenthetical information, recognize boundaries of biological terms and identify biological terms.

In some embodiments of the disclosed subject matter, the boundary identifier can identify section and sentence boundaries, drop irrelevant information, and utilize a lexicon lookup to implement syntactical and semantic tagging of relevant information. The boundary identifier can be associated with a lexicon module, which provides a suitable lexicon from external knowledge sources. The output of the boundary identifier can include a list of word positions where each position is associated with a word or multi-word phrase in the text. In addition, each portion in the list can be associated with a lexical definition consisting of semantic categories and a target output form.

In some embodiments of the disclosed subject matter, the parser can utilize grammar rules and categories assigned to the phrases of a sentence to recognize well-formed syntactic and semantic patterns in the sentence and to generate intermediate forms.

In some embodiments of the disclosed subject matter, the phrase regulator can replace parsed forms with a canonical output form specified in the lexical definition of the phrase associated with its position in the report.

In some embodiments of the disclosed subject matter, the encoder can map received canonical forms into controlled vocabulary terms through a table of codes. The codes can be used to translate the regularized forms into unique concepts which are compatible with a controlled vocabulary.

In some embodiments of the disclosed subject matter, lexical definitions can be added or changed, e.g., by the user.

In other embodiments of the disclosed subject matter, section names that can be recognized can be customized and/or extended, e.g., by the user.

The accompanying drawings, which are incorporated and constitute part of this disclosure, illustrate preferred embodiments of the invention and serve to explain the principles of the invention.

### BRIEF DESCRIPTION OF THE DRAWINGS

FIG. 1 is a block diagram of an information extraction system in accordance with some embodiments of the disclosed subject matter;

FIG. 2 is a diagram illustrating a method implemented in accordance with some embodiments of the disclosed subject matter in the pre-processor module 10 of FIG. 1;

FIG. 3 is a diagram illustrating a method implemented in accordance with some embodiments of the disclosed subject matter in the boundary identification module 11 of FIG. 1; and

FIG. 4 is a block diagram of a system or application having an interface that may be used in connection with some embodiments of the system of FIG. 1.

Throughout the drawings, the same reference numerals and characters, unless otherwise stated, are used to denote like features, elements, components or portions of the illustrated embodiments. Moreover, while the present invention will now be described in detail with reference to the Figs., it is done so in connection with the illustrative embodiments.

### DETAILED DESCRIPTION

An improved natural language processing (“NLP”) system is presented to process information obtained from medical and other literature which includes complex genotypic and phenotypic terms. The system extracts and encodes genotype-phenotype information from text, and includes a flexible infrastructure for mapping textual terms to codes. As used herein, the term “genotype-phenotype information” refers to genotype information, phenotype information, a combination of both and/or information concerning relationships with genotype and/or phenotype information.

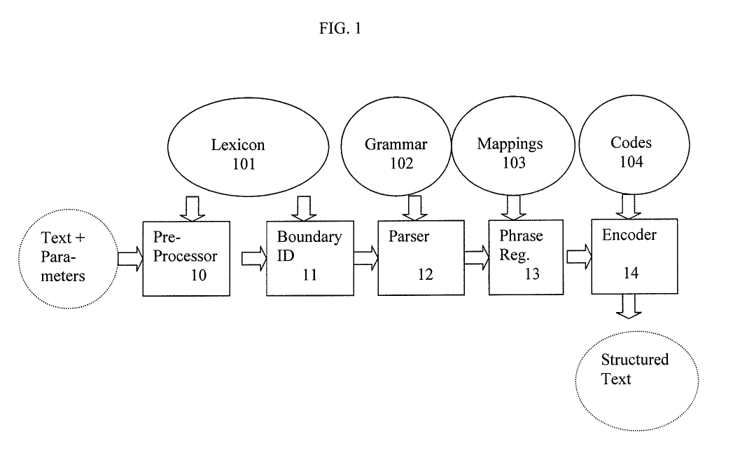

FIG. 1 is a block diagram of an information extraction system in accordance with an embodiment of disclosed subject matter. The system includes preprocessor 10, boundary identifier 11, parser 12, phrase recognizer 13, and encoder 14. These system components use a lexicon 101, grammar rules 102, mappings 103 and codes 104 to convert natural-language input text and parameters received by the preprocessor 10 into structured text output by encoder 13. The structured text can take the form of codes which account for genotype-phenotype relations and are compatible with a controlled vocabulary.

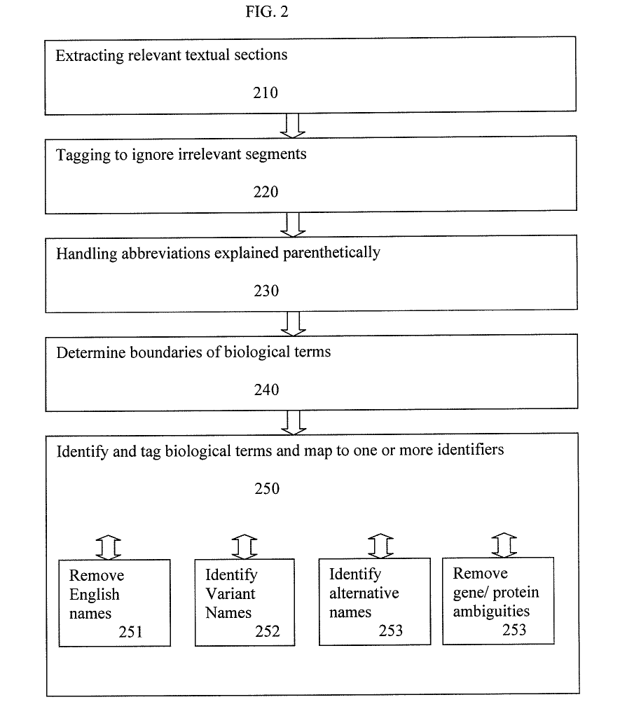

The preprocessor 10 receives natural-language input text and parameters, and outputs words where biological terms are tagged. In some embodiments that will be further described with reference to FIG. 2, the preprocessor can extract relevant text, perform tagging so that irrelevant text is ignored, handle parenthetical information, recognize boundaries of biological terms and identify biological terms.

For example, if the input sentence is Wnt5a regulates the proliferation of progenitor cells, the output after preprocessor 10 can be <phr sem-“gp” t=“MGI:98958̂Wnt5a”> Wnt5a</phr> regulates the proliferation of progenitor cells. In this example, Mouse genomics informatics identifiers (“MGI”) are used to tag and identify Wnt5a. However, different biological ontology schemes could be used, for example, Entrez Gene. In this case the output would be <phr sem-“gp” t=“GeneID:22418̂Wnt5â10090”> Wnt5a</phr> regulates the proliferation of progenitor cells.

Tags can be formed in the following manner. Each identifier can be assigned (a) a prefix specifying the nomenclature (in the last example GeneID), followed by (b) an identifier from that nomenclature, followed by (c) the official symbol and followed by (d) (if the ontology contains multiple species), the taxonomy identifier for the species. If the term is ambiguous, alternative identifiers can be included in the target string, delimited by an appropriate symbol, such as ‘!’. In the example, Wnt5a is not ambiguous if the article associated with the sentence concerned is assumed to be the mouse.

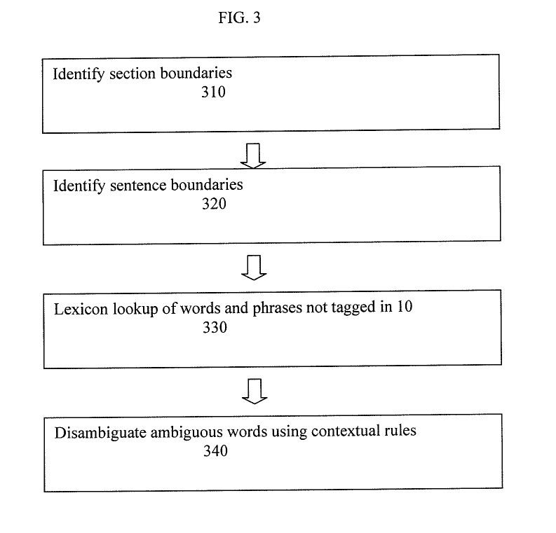

The output from preprocessor 10 is provided to boundary identifier 11. In some embodiments that will be further described with reference to FIG. 3, the boundary identifier 11 can identify section and sentence boundaries, drop irrelevant information, and utilize a lexicon lookup to implement syntactical and semantic tagging of relevant information. The boundary identifier 11 is associated with the Lexicon module 101, which provides a suitable lexicon from external knowledge sources.

The output of boundary identifier 11 can include a list of word positions where each position is associated with a word or multi-word phrase in the text. In addition, each portion in the list can be associated with a lexical definition consisting of semantic categories and a target output form.

For example, if the sentence Wnt5a regulates the proliferation of progenitor cells is the first sentence of an article, the list of positions will be [1,3,7,9,11]. The positions that do not have any relevance (semantic or syntactic categories) for extraction may be ignored as they are not used in the next module (parser 12), but their positions in the text are retained. For example, blanks, although they were used to separate words, do not have any information otherwise. Words such as “a” and “the” can also be considered to be not relevant. The lexical entry associated with position 1, which is associated with Wnt5a, can be assigned the semantic category gp (for gene/protein) and the target form included in the tag. The remaining lexical entries can be provided by lexical lookup in module 11. For example, position 3 can be associated with the semantic category genefunc and target form regulation, and the phrase at position 11 with the semantic category cell for the multi-word phrase ‘progenitor cell’.

The output from the boundary identifier 11 is provided to parser 12. In some embodiments, the parser 12 can utilize grammar 112 and categories assigned to the phrases of a sentence to recognize well-formed syntactic and semantic patterns in the sentence and to generate intermediate forms.

For example, for the sentence Wnt5a regulates the proliferation of progenitor cells, the output can have two parts. The first part can contain contextual information, such as the sentence identifier, section name, and parse mode which will later become part of the extracted information but is kept separate at this stage ([[sid,[1,1,1],[sectname,unknown], [parsemode,1]]. The second part can contains the structured output extracted from the sentence ([genefunc,3,[gene_geneproduct,1,[arg,agent]],[bodyfunc,7, [cell,11], [arg,target]]]): [[[sid, [1,1,1], [sectname,unknown],[parsemode,1]],[genefunc,3, [gene_geneproduct,1,[arg,agent]],[bodyfunc,7,[cell,11],[arg,target]]].

In some embodiments, the parser module 12 uses a lexicon 101 and a grammar module 102 to generate intermediate target forms. Thus, in addition to parsing of complete phrases, sub-phrase parsing can be used to advantage where highest accuracy is not required. In case a phrase cannot be parsed in its entirety, one or several attempts can be made to parse a portion of the phrase for obtaining useful information in spite of some possible loss of information. For example, if the sentence were Wnt5a regulates the proliferation of progenitor cells, which is a novel discovery, the last phrase, which is a novel discovery, may not be successfully parsed. In that case, it still will be possible to successfully parse the beginning of the sentence Wnt5a regulates the proliferation of progenitor cells as before, and the output will be similar to that described above.

In this form, the frame can represent the type of information, and the value of each frame is a number representing the position of the corresponding phrase in the report. In a subsequent stage of processing, the number can be replaced by an output form that is the canonical output specified by the lexical entry of the word or phrase in that position and a reference to the position in the text.

The parser can proceed by starting at the beginning of the sentence position list and following the grammar rules. When a semantic or syntactic category is reached in the grammar, the lexical item corresponding to the next available unmatched position can be obtained and its corresponding lexical definition is checked to see whether or not it matches the grammar category. If it does match, the position can be removed from the unmatched position list, and the parsing continued. If a match is not obtained, an alternative grammar rule can be tried. If no analysis can be obtained, an error recovery procedure can be followed so that a partial analysis is attempted.

The output from the parser 12 is provided to phrase regulator 13. In some embodiments of the disclosed subject matter, the regulator 13 can first replace each position number with the canonical output form specified in the lexical definition of the phrase associated with its position in the report. It also can add a new modifier frame, for example “idref”, for each position number that is replaced, and insert contextual information into the extracted output so that contextual information is no longer a separate component. Further, the regulator 13 can also compose multi-word phrases, i.e., compositional mappings, which are separated in the documents.

For example, the output of the at this stage can be: [genefunc,regulation,[idref,3], [gene_geneproduct,MGI:95958̂Wnt5a,[idref,1], [arg,agent]], [bodyfunc,proliferation,[idref,7], [cell,‘progenitor cell’,[idref,11],[arg,target]]], [sid,[1,1,1]], [sectname,unknown],[parsemode,1]]. With the parsed text as an input, and using mapping information 103, the phrase regulation module 13 composes regular terms as described above. In this example, this is not necessary since no multi-word phrase has been separated in the sentence.

The compositional mapping information 103 lists the components of complex terms. For example, a mapping could list “regulation of progenitor cell” to consist of the target form [genefunc,regulation,[cell,‘progenitor cell’]], in which case the output can be mapped to:

[genefunc,‘regulation of progenitor cell’,[idref,3,11],
[gene_geneproduct,MGI:95958\hat{ }Wnt5a,[idref,1], [arg,agent]],
[bodyfunc,proliferation,[idref,7], [cell,’progenitor
cell’,[idref,11],[arg,target]]], [sid,[1,1,1]],
[sectname,unknown],[parsemode,1]

The encoder 14 receives the regulated phrases. In some embodiments of the disclosed subject matter, the encoder 14 maps received canonical forms into controlled vocabulary terms through a table of codes 104. The codes can be used to translate the regularized forms into unique concepts which are compatible with a controlled vocabulary.

For example, the output of the encoder 14 can be:

[genefunc,regulation,[idref,3],
[gene_geneproduct,MGI:95958\hat{ }Wnt5a,[idref,1],
[arg,agent]],[bodyfunc,proliferation,[idref,7], [cell,’progenitor
cell’,[idref,11]],[arg,target],[code,’UMLS:C0038250\hat{ }stem cell’,[idref,11]],
[code,’GO:0050789\hat{ }regulation of biological process’,[idref,3]],
[sid,[1,1,1]], [sectname,unknown],[parsemode,1]]

A coding table 104 can generated. In one arrangement, the table takes the form of (A₁, A₂, A₃ A₄), where A₁ represents the main finding used for efficiency, A₂ represents the type of main finding, A₃ represents a list of modifiers, and A₄ indicates the coding system, such as a preferred name in ontology. Exemplary codes in the form (A₁, A₂, A₃, A₄) are shown below in Table A.

TABLE A

| Number | Code |
|---|---|
| 1 | (‘anterior myocardial infarction’, problem, [[status, |
| | ‘indeterminate age’]], ‘UMLS: C0948864_age indeterminate |
| | anterior myocardial infarction’) |
| 2 | (‘anterior myocardial infarction’, problem, [[status, acute]], |
| | ‘UMLS: C0340293_myocardial infarction anterior’) |
| 3 | (‘anterior myocardial infarction’, problem, [[status, previous]], |
| | ‘UMLS: C0340320_old anterior myocardial infarction’) |
| 4 | (‘anterior myocardial |
| | infarction’, problem, [ ], ‘UMLS: C0340293_myocardial |
| | infarction anterior’) |
| 5 | (‘anterolateral myocardial |
| | infarction’, problem, [[proceduredescr, electrocardiogram]], |
| | ‘UMLS: C0232321_anterolateral infarction by ekg’) |
| 6 | (‘anterolateral myocardial infarction’, problem, [[status, |
| | ‘indeterminate age’]], ‘UMLS: C1142565_age indeterminate |
| | anterolateral myocardial infarction’) |
| 7 | (‘anterolateral myocardial infarction’, problem, [[status, acute]], |
| | ‘UMLS: C0155627_acute myocardial infarction of anterolateral |
| | wall’) |

A tagger (not shown) can be used to “tag” the original text data with a structured data component. For example, XML tagging may be employed. If it is, the sample structured output can be: <genefunc v=“regulation” idref=“p3”> <gene_geneproduct v=“MGI:95958̂Wnt5a” idref=“p1> <arg v=“agent”></arg></gene_gproduct> <bodyfunc v=“proliferation” idref=“p7”> <cell v=“progenitor cell” idref=“p11”> <code v=“UMLS:C0038250̂stem cell” idref=“p11”></code> </cell><arg v=“target”></arg> <code v=“GO:0050789̂regulation of biological process” idref=“p3”></code> </bodyfunc> <sid v=“p1.1.1”></sid><sectname v=“unknown”></sectname><parsemode v=“p1”></parsemode></genefunc>.

Referring next to FIG. 2, an exemplary software embodiment of the pre-processor module 10 of FIG. 1 will be described. At 210, relevant textual sections, such as titles, abstracts, and results, are extracted from the input text. Relevant text is extracted from XML documents based on knowledge of which elements are textual elements. For example, the text of the title, abstract, introduction, methods, results, discussion, conclusion sections can be selected for processing, but not the text of the authors, affiliations, or acknowledgement sections.

Other types of text documents, such as HTML, can likewise be processed by employing suitable programming. This would entail looking for certain fonts (such as large bold) and certain strings, such as “methods”.

The extracted text is tagged 220 so that certain segments of textual information, such as tables, background, and explanatory sentences, can be ignored going forward. Once such a segment is recognized, a tag, such as <ign>, can be placed at beginning of segment and a second tag, such as </ign>, can be placed at end of segment. Text between the “ign” tags can be subsequently ignored.

Next, abbreviated terms that are defined in the input text by way of parenthetical expressions can be operated on 230. Methods suitable for use in some embodiments of 230 are explained by way of the example below. However, the disclosed subject matter is not limited to these techniques and embraces alternative techniques for converting abbreviated terms and/or parenthetical information.

### Example

In this example, the text to be operated on consists of the following passage
The forkhead box f1 (Foxf1) transcription factor is expressed in the visceral (splanchnic) mesoderm, which is involved in mesenchymal-epithelial signaling required for development of organs derived from foregut endoderm such as lung, liver, gall bladder, and pancreas. Our previous studies demonstrated that haploinsufficiency of the Foxf1 gene caused pulmonary abnormalities with perinatal lethality from lung hemorrhage in a subset of Foxf1+/−newborn mice. During mouse embryonic development, the liver and biliary primordium emerges from the foregutendoderm, invades the septum transversum mesenchyme, and receives inductive signaling originating from both the septum transversum and cardiac mesenchyme. In this study, we show that Foxf1 is expressed in embryonic septum transversum and gall bladder mesenchyme. Foxf1+/−gall bladders were significantly smaller and had severe structural abnormalities characterized by a deficient external smooth muscle cell layer, reduction in mesenchymal cell number, and in some cases, lack of a discernible biliary epithelial cell layer. This Foxf1+/−phenotype correlates with decreased expression of vascular cell adhesion molecule-1 (VCAM-1), alpha(5) integrin, platelet-derived growth factor receptor alpha (PDGFRalpha) and hepatocyte growth factor (HGF) genes, all of which are critical for cell adhesion, migration, and mesenchymal cell differentiation.

First, any defined parenthesized expressions in the text are located. This can be repeated through the text to find expressions in parenthesis as a separate phrase or word, since parenthetical expression could be a part of some biomedical term, like chemical). Second, as will be described in further detail below, a full form is located for the defined abbreviations. Third, parenthesized expressions are replaced with dummy entries. Fourth, a mapping table linking abbreviations to full forms can be created for the future use.

In order to determine a full form for a defined abbreviation, the boundaries for possible full form (“PFF”) text within the parenthesized expression (“PE”) are determined. In one embodiment, a number of assumptions can be made to facilitate such determination, as follows:
1. The number of words in PFF can not be more then number of symbols in PE plus two, if the PFF contains words gene, protein, antigen, etc., or plus one otherwise.
2. A PFF can not include any previous PE.
3. A PFF can not include words from previous sentence or any part of the same sentence, separated by comma or other punctuation marks.
4. A PFF can not start from words like “the”, “a”, “or”, “by”, and etc.
5. A decision can be made regarding whether a PE is an abbreviation based on the length or special symbols in it.
6. Some explanations within PE may be eliminated, such as “also known” or “also named”.

Once the boundaries for possible full form text within parenthesized expressions are determined, an exact full form (“EFF”) for text within the parenthesized expressions can be determined. In one embodiment, an attempt will be made to find an exact match, with each symbol in the parenthesized expression matched to the first symbol in each word in the possible full form, excluding any characters like “-”, “.”, or “ ”. If this is unsuccessful, auxiliary words such as gene, protein, etc. can be removed, and another attempt can be made to find an exact match. If this is still unsuccessful, Greek letters and numerical prefixes such as “tri” can be replaced with English counterparts, and another attempt can be made to find an exact match. If none of above succeeded, the shortest string which starts with the first letter in the abbreviation can be chosen, and a match attempted as a pattern. For example EDA matches to “ectodermal dysplasia” or GPI matches “glycosylphosphatidylinositol”

Using example 1, the output from 230 can be as shown below:

Foxf1|forkhead box f1|Foxf1
HGF|hepatocyte growth factor|HGF
PDGFRalpha|platelet-derived growth factor receptor
alpha|PDGFRalpha
VCAM-1|vascular cell adhesion molecule-1|VCAM-1
1||MEDLEE1|HGF|hepatocyte growth factor||
1||MEDLEE2|PDGFRalpha|platelet-derived growth factor receptor
alpha||
1||MEDLEE3f|vascular cell adhesion molecule-1 (VCAM-1)|vascular
cell adhesion molecule-1||
1||MEDLEE2f|platelet-derived growth factor receptor alpha
(PDGFRalpha)|platelet-derived growth factor receptor alpha||
1||MEDLEE3|VCAM-1|vascular cell adhesion molecule-1||
1||MEDLEE1f|hepatocyte growth factor (HGF)|hepatocyte growth
factor||
6||MEDLEE0|Foxf1|forkhead box f1||
1||MEDLEE0f|forkhead box f1 (Foxf1)|forkhead box f1||
1||NOTABBR0|(splanchnic)||

Title:
Haploinsufficiency of the mouse MEDLEE0f gene causes defects in gall bladder development.

Abstract:
The MEDLEE0f transcription factor is expressed in the visceral NOTABBR0 mesoderm, which is involved in mesenchymal-epithelial signaling required for development of organs derived from foregut endoderm such as lung, liver, gall bladder, and pancreas. Our previous studies demonstrated that haploinsufficiency of the MEDLEE0 gene caused pulmonary abnormalities with perinatal lethality from lung hemorrhage in a subset of MEDLEE0 PLUSMIN newborn mice. During mouse embryonic development, the liver and biliary primordium emerges from the foregutendoderm, invades the septum transversum mesenchyme, and receives inductive signaling originating from both the septum transversum and cardiac mesenchyme. In this study, we show that MEDLEE0 is expressed in embryonic septum transversum and gall bladder mesenchyme. MEDLEE0 PLUSMIN gall bladders were significantly smaller and had severe structural abnormalities characterized by a deficient external smooth muscle cell layer, reduction in mesenchymal cell number, and in some cases, lack of a discernible biliary epithelial cell layer. This MEDLEE0 PLUSMIN phenotype correlates with decreased expression of MEDLEE3f, alpha(5) integrin, MEDLEE2f and MEDLEE1f genes, all of which are critical for cell adhesion, migration, and mesenchymal cell differentiation.

MEDLEE1|HGF|hepatocyte growth factor
MEDLEE2|PDGFRalpha|platelet-derived growth factor receptor alpha
MEDLEE3f|vascular cell adhesion molecule-1 (VCAM-1)|vascular
cell adhesion molecule-1
MEDLEE2f|platelet-derived growth factor receptor alpha
(PDGFRalpha)|platelet-derived growth factor receptor alpha
MEDLEE3|VCAM-1|vascular cell adhesion molecule-1
MEDLEE1f|hepatocyte growth factor (HGF)|hepatocyte growth factor
MEDLEE0|Foxf1|forkhead box f1
MEDLEE0f|forkhead box f1 (Foxf1)|forkhead box f1
NOTABBR0|(splanchnic)

Returning to FIG. 2, the next operation performed by pre-processor 10 can be the determination of boundaries of biological terms contained in the extracted text 240. Methods suitable for use in some embodiments of 240 will next be explained with reference to the illustrative text of example 1 and the well-known TreeTagger tool for annotating text with part-of-speech (“POS”) and lemma information, developed within the TC project at the Institute for Computational Linguistics of the University of Stuttgart (http://www.ims.uni-stuttgart.de/projekte/corplex/TreeTagger/DecisionTreeTagger.html). However, the disclosed subject matter is not limited to this tool and embraces alternative techniques for text boundary determination.

First, TreeTagger is run to recognize so-called “bioterms”, i.e., biomolecular entities since such entities as these are extremely irregular due to the inclusion of punctuation, greek, numbers, multiple words connected by hyphens, etc. The output of the TreeTagger can take the following form:

Haploinsufficiency NN <unknown>
of IN of
the DT the
mouse NN mouse
MEDLEE0f NN <unknown>
gene NN gene
causes VVZ cause
defects NNS defect
in IN in
gall NN gall
bladder NN bladder
development NN development
. SENT .
The DT the
MEDLEE0f NP <unknown>
transcription NN transcription
factor NN factor
is VBZ be
expressed VVN express
in IN in
the DT the
visceral JJ visceral
NOTABBR0 JJ <unknown>
mesoderm NN mesoderm

Next, the TreeTagger output can be modified to fix words with parenthesis that were incorrectly processed. This can be accomplished by a set of rules to recognize parenthesis and treat accordingly. For example, the following illustrative rules are used in some embodiments:
1. Change part of speech “POS” tags for words which contain defined abbreviations marked as MEDLEEN# in 230.
2. Make all Proper Nouns (NP) unknown, as they may be biomedical terms.
3. Lookup any unknown word in the lexicon 101 to determine if it is defined. If it is, remove the “<unknown>” tag. This is done only for those words which are not biological terms, that is, terms which include typographical symbols, alpha-numeric symbols, mixed case words, and/or other unusual pattern.
4. Identify noun phrases.
   a. Fix incorrect POS tags for some biological term names, such as numbers (CD) which are actually proper nouns. For example, a POS tag CD (number) for BAL-17, can be changed to NP (proper noun).
   b. Define a noun phrase as a phrase which contains only nouns, adjectives and numbers and ends with a noun, number, or Greek letter.
   c. Select and print noun phrases which have at least one unknown word.

The output of the tree Tagger, as modified by these exemplary rules, can take the following form:

Haploinsufficiency|<unknown>/NP
mouse/NN MEDLEE0f|<unknown>/NP gene/NN
MEDLEE0f|<unknown>/NP transcription/NN factor/NN
MEDLEE0|<unknown>/NP gene/NN
MEDLEE0|<unknown>/NP PLUSMIN|<unknown>/NP
newborn/JJ mice/NNS
MEDLEE0|<unknown>/NP
MEDLEE0|<unknown>/NP PLUSMIN|<unknown>/NP
gall/NN bladders/NNS
MEDLEE0|<unknown>/NP PLUSMIN|<unknown>/NP
phenotype/NN correlates/NNS
MEDLEE3f|<unknown>/NP
alpha(5)|<unknown>/NP integrin|<unknown>/NN
MEDLEE2f|<unknown>/NP
MEDLEE1f|<unknown>/NP genes/NNS

Next, boundaries of noun phrases that have unknown words in original text can be marked. These boundaries are boundaries for possible biomedical entities. For example:

Title: {{{Haploinsufficiency}}} of the {{{mouse forkhead box f1
gene}}} causes defects in gall bladder development. Abstract: The
{{{forkhead box f1 transcription factor}}} is expressed in the visceral
NOTABBR0 mesoderm, which is involved in mesenchymal-epithelial
signaling required for development of organs derived from foregut
endoderm such as lung, liver, gall bladder, and pancreas. Our previous
studies demonstrated that haploinsufficiency of the {{{Foxf1 gene}}}
caused pulmonary abnormalities with perinatal lethality from lung
hemorrhage in a subset of {{{Foxf1 PLUSMIN newborn mice}}} .
During mouse embryonic development, the liver and biliary
primordium emerges from the foregut endoderm, invades the septum
transversum mesenchyme, and receives inductive signaling originating
from both the septum transversum and cardiac mesenchyme. In this
study, we show that {{{Foxf1}}} is expressed in embryonic septum
transversum and gall bladder mesenchyme. {{{Foxf1 PLUSMIN gall
bladders}}} were significantly smaller and had severe structural
abnormalities characterized by a deficient external smooth muscle cell
layer, reduction in mesenchymal cell number, and in some cases, lack
of a discernible biliary epithelial cell layer. This {{{Foxf1 PLUSMIN
phenotype correlates}}} with decreased expression of {{{vascular
cell adhesion molecule-1}}} , {{{alpha(5) integrin}}} , {{{platelet-
derived growth factor receptor alpha}}} and {{{hepatocyte growth
factor genes}}} , all of which are critical for cell adhesion, migration,
and mesenchymal cell differentiation.

Returning to FIG. 2, the next operation performed by pre-processor 10 can be the identification and tagging of biological terms 250. Terms can be identified and mapped to one or more identifiers using the Lexicon 101. Thus gene names contained in the extracted text can be mapped to gene identification information, which can be contained in a separate database.

In some embodiments, 250 may be implemented by ignoring certain common language words 251, identifying variant names 252, identifying alternative gene, proteins and gene products 253, and removing ambiguities between genes and protein names 254.

When the lexicon 101 is created from an existing ontology (such as cell ontology), new terms can be generated by varying the terms in the ontology 252. For example, lexical entries for plural cell names can be created from singular cell names by adding ‘s’; adjectival variants are created by change terms with suffix ‘-cyte’ to ‘-cytic’. This can be based on heuristic knowledge of language variations for these terms.

An exemplary method for identifying and tagging each noun phrase (or part of it, which has unknown words, because these could be biological entities), will now be described. First, an attempt is made to identify a complete noun phrase and tag it suitable for parsing. This entails a determination of a semantic category based on the noun phrase context. If the phrase includes the word “gene”, “protein” or other words created by analyzing noun phrases which are specific for the gene/protein names, or an original abstract has this phrase followed by the words null, dependent, independent or PLUS, MIN, set a semantic type to “gene”. If the text or the phrase has word cell or cell line, set a semantic type to “cell”, otherwise set a semantic type to “null”, which prevents from identifying the term as a gene or gene protein.

With the semantic type into the account, an attempt is made to identify a complete noun phrase. If unsuccessful, numbers and known English verbs from the beginning of the phrase, adjectives from the beginning of the phrase, and species names from the beginning of the phrase can be removed, and an attempt made to identify the remaining phrase. If unsuccessful again, gene functions (as they are defined in the lexicon 101, such as “inhibitor”, “activity”) or words, which are specific for gene names (GeneEnds), can be removed from the end of the phrase, and another attempt made to identify the remaining phrase. Finally, the noun phrase can be tagged if the lookup is successful. It should be noted that for terms with full and abbreviated forms, it may be preferable to try to identify a full form first, and if it is not defined, to lookup abbreviated form.

When the phrase has special words or verb-derivatives in the middle, e.g., “specific”, “induced”, “ . . . ed”, “ . . . ive”, “ . . . ient”, the noun phrase can be broken up into two parts, repeating the same process as for the complete noun phrase. If the phrase has +/+, −, −/+ or other similar nomenclature in the middle of the phrase, the noun phrase can be split on these symbols, and the same process applied as for the complete noun phrase assuming semantic category gene/protein “gp”, assuming each part is a gene or protein instance.

Additional information for elements in expressions in parentheses can often be obtained from context outside of parentheses. For example, cell lines ( . . . , . . . and . . . ) or; proteins ( . . . , . . . and . . . ) or; genes ( . . . , . . . and . . . ) or; cells ( . . . , . . . and . . . ), to build a local knowledge base of biomedical terms for an additional lookup source.

Next, noun phrases can be replaced with their tagged versions. If a noun phrase does not have any tagging, but has a “bioterm” (mixed case or alpha-numeric word), the bioterm can be extracted, and an attempt made to identify a semantic category based on the context. If the bioterm is not identified, tag it as <bioterm>. Finally, parenthetical expressions that are not abbreviations can be replaced and analyzed as noun phrases. The output of 250 can take the following form:

Title:
Haploinsufficiency of the mouse <phr sem=“gp”
t=“GeneID:2294\hat{ }FOXF1\hat{ }9606”> forkhead box f1 </phr> gene causes
defects in gall bladder development.
Abstract:
The <phr sem=“gp” t=“GeneID:2294\hat{ }FOXF1\hat{ }9606”> forkhead box f1
</phr> transcription factor is expressed in the visceral (splanchnic)
mesoderm, which is involved in mesenchymal-epithelial signaling
required for development of organs derived from foregut endoderm
such as lung, liver, gall bladder, and pancreas.
Our previous studies demonstrated that haploinsufficiency of the <phr
sem=“gp” t=“GeneID:2294\hat{ }FOXF1\hat{ }9606”> Foxf1 </phr> gene
caused pulmonary abnormalities
with perinatal lethality from lung hemorrhage in a subset of <phr
sem=“gp” t=“GeneID:2294\hat{ }FOXF1\hat{ }9606”> Foxf1 </phr> +/−
newborn mice . During mouse embryonic development, the liver and
biliary primordium emerges from the foregut endoderm, invades the
septum transversum mesenchyme, and receives inductive signaling
originating from both the septum transversum and cardiac
mesenchyme. In this study, we show that <phr sem=“gp”
t=“GeneID:2294\hat{ }FOXF1\hat{ }9606”> Foxf1 </phr>
is expressed in embryonic septum transversum and gall bladder
mesenchyme. <phr sem=“gp” t=“GeneID:2294\hat{ }FOXF1\hat{ }9606”> Foxf1
</phr> +/− gall bladders were significantly smaller and had severe
structural abnormalities characterized by a deficient external smooth
muscle cell layer, reduction in mesenchymal cell number, and in some
cases, lack of a discernible biliary epithelial cell layer. This <phr
sem=“gp” t=“GeneID:2294\hat{ }FOXF1\hat{ }9606”> Foxf1 </phr> +/−
phenotype
correlates with decreased expression of <phr sem=“gp”
t=“GeneID:22329\hat{ }Vcam1\hat{ }10090!GeneID:25361\hat{ }Vcam1\hat{ }10116!Gene
ID:7412\hat{ }VCAM1\hat{ }9606”> vascular cell adhesion molecule-1 </phr> ,
<phr sem=“gp” t=“alphav integrin”> alpha(5) integrin </phr> , platelet-
derived growth factor receptor alpha and <phr sem=“gp”
t=“GeneID:15234\hat{ }Hgf\hat{ }10090!GeneID:24446\hat{ }Hgf\hat{ }10116”>
hepatocyte growth factor </phr> genes , all of which are critical for
cell adhesion, migration, and mesenchymal cell differentiation.

In addition, ambiguities can be resolved 254 by employing a suitable statistical methodology to tag the ambiguity so that it will be treated throughout the text in accordance with single determined meaning.

In some embodiments, lexical definitions or entries can be added or changed, e.g., by the user through a suitable input, such as a client computer 410. To add new lexical entries, files can be created containing the lexical entries, and options can be used referencing the file names. For example, in one embodiment, an option can be selected to specify a domain-specific lexicon, in which the user-specified words and phrases replace those in the regular lexicon. In this manner, dynamic definitions can be specified which replace the definitions in the regular lexicon, which is useful when customizing the system for a specific domain. In another exemplary embodiment, an option can be selected to specify user-defined additions to the lexicon. This allows the user to create a file that enables the user to dynamically update the lexicon, specifying additional terms. For example, in one embodiment, a lexicon file can be formatted in the following manner: term|semantic category|target form. Examples of lexicon files are as follows:

/acetaminophen|med|acetaminophen/
/abdominal wall|bodyloc|abdomen/
/abg|labtest|arterial blood gas/
/Huntington's disease|cfinding|Huntington's disease/

Referring next to FIG. 3, an exemplary software embodiment of boundary identifier 11 of FIG. 1 will be described. First 310, section boundaries are identified. This can be accomplished using a list of known sections which identifies terms, e.g., by including a ‘:’ Typical known sections include terms such as Abstract, Methods, Results, Conclusions.

In some embodiments, section names can be customized and/or extended e.g., by the user. For example, in one embodiment, a file is created containing the section names and an option is used when running the program to specify the customized section file. These files have a specific format that is recognized by the program, enabling the user to supply separate input and output file names, if desired. Exemplary file formats are as follows:

review of systems.
ros|review of systems.

Next 320, sentence boundaries are identified. Sentence boundaries are determined when there are certain punctuations, such as ‘.’ and ‘;’. For ‘.’ a procedure can be employed to test if the period is an abbreviation. If it is an abbreviation, it is not treated as the end of a sentence and the next appropriate punctuation is tested.

At 330, a lexicon look-up is performed. In some embodiments, this can involve both syntax tagging, e.g., to identify nouns and verbs within the text, and semantic tagging, e.g., to identify disease names, relations, functions, body locations, etc. During the look-up, certain information can be ignored by employing string matching, i.e., finding the longest string in the lexicon that matches the text. For example, in the text segment ‘the liver and biliary primordium’, ‘the’ can be ignored because it is in the list of words that can be ignored, ‘liver’ can be matched and the lexicon will specify that it is a body location, ‘and’ can be specified as a conjunction, and ‘biliary primordium’ as a body location.

Next 340, contextual rules can be used to disambiguate ambiguous words. This can be implemented through use of contextual disambiguation rules which can look at words following or preceding the ambiguous word or at the domain.

Returning to FIG. 1, the lexicon 101 can contain both terms and semantic classes, as well as target output terms. For example, lexical entries for cell ontology can include fibrobast, fibrobasts, fibrobastic, and the target form for all can be fibroblast. The lexicon can be created using an external knowledge source. For example, Cell Ontology can list the names of certain cells.

The grammar rules 102 can check for both syntax and semantics, and constrain arguments of relation or function. The arguments themselves can be nestled such that rules build upon other rules. A set of exemplary grammar rules are provided in Table B below, where “*” indicates a general English-like class, and “+” indicates an outdated class to be avoided.

TABLE B

| Category | Description | Examples |
|---|---|---|
| bioterm | terms that look like a biological | |
| | entity but exact type is unknown | |
| bodyloc | a well-defined body location or part | heart’, ‘lung’, ‘achilles |
| | | tendon’, ‘respiratory system’ |
| bodyfunc | a body function | ‘gait’, ‘movement’, ‘meiosis’ |
| bodymeas | a measurable entity associated with body | ‘heart rate’, ‘blood pressure’, |
| | | ‘sat’ |
| cell | a cell | ‘fibroblast’, ‘hepatocyte’ |
| cell component | a subcellular component | ‘nucleus’, ‘membrane’ |
| certainty* | modifier associated with presence of | ‘no’, ‘possible’, ‘seen’ |
| | a finding | |
| cfinding | complete abnormal finding | ‘enlarged heart’, ‘tender |
| | (descriptor + bodyloc, bodyloc can | abdomen’ |
| | be implied) | ‘sickle cell disease’, |
| | | ‘acidosis’ |
| change | change of state | ‘increase’, ‘improved’ |
| conj* | conjunction | ‘and’, ‘but’, ‘or’ |
| descriptor | descriptor of a body location/finding/ | ‘small’, ‘round’ |
| | bodymeas/bodyfunc | |
| degree* | degree modifier | ‘severe’, ‘moderate’ |
| device | a medical device applied to patient | tube’, ‘foley catheter’ |
| | | ‘pacemaker’, |
| | | bandage’, ‘compress’ |
| disease+ | a disease | ‘sickle cell disease’ |
| freq* | denoting frequency of event | ‘bid’, ‘times two’, ‘daily’ |
| gene | a gene | ‘mtrnr2 gene’, ‘p53 gene’ |
| gene_gproduct | a gene or gene product | ‘p53’, ‘il-2’ |
| genotype | genetic descriptor or mutation | ‘heterozygote’, ‘wild-type’, |
| | | ‘mutant’ |
| gdescriptor | descriptor of some finding but not of | ‘congenital’, ‘external’ |
| | a body location | |
| genefunc | genomic function - may also include | ‘inhibition’, ‘activation’ |
| | cellular functions | |
| integer | whole numbers | ‘one’, ‘2’ |
| labproc | laboratory procedure | ‘liver function test’, |
| | | ‘urinanalysis’ |
| manner | method of administering medication | ‘intravenous’, ‘intravenous |
| | | push’ |
| meddescr | descriptor of medication | ‘over the counter’, ‘anti- |
| | | inflammatory’ |
| month | name of month | ‘July’, ‘December’ |
| neg | negation term | ‘no’, ‘none’ |
| nfinding | a finding which signifies a normal | ‘responsive’, ‘alert’ |
| | condition | |
| number | numbers with decimal | ‘1.5’, ‘2.0’ |
| ordinal | ordinal number | ‘first’, ‘second’ |
| organism | a non-pathogenic organism | ‘mouse’, ‘human’ |
| pathogen | an organism that is a pathogen - | ‘e. coli’, ‘acetobacter’ |
| | includes bacteria, virus, fungus | |
| pfinding | abnormal finding without a body | ‘enlarged’, ‘swelling’ |
| | location | |
| ploc* | locative preposition - locative | ‘under’, ‘over’, ‘below’ |
| | modifier of | |
| | a body location | |
| proc | procedure | ‘amputation’, ‘abd protocol’ |
| protein | a protein | ‘centromere protein a’ |
| quantity* | quantity information | ‘few’, ‘numerous’, ‘multiple’, |
| | | ‘one’ |
| region | a relative qualifier of a body location | ‘left’, ‘upper’, ‘sulcus’ |
| | or a unit of a body location | |
| relation | words/phrases that connect different | ‘cause’, ‘associated with’ |
| | entities | |
| sex | male or female | |
| status | qualifier relating to type of onset of | ‘acute’, ‘previous’, ‘new’ |
| | finding | |
| | or to time of onset & other temporal | |
| | Information | |
| strain | organism strain | ‘NB41’, ‘NOD’ |
| substance | a molecule, chemical, or | ‘absorbase’, ‘pericalline’ |
| | pharmacologic substance | |
| technique | method use | ‘alkaline, comet, assay’, |
| | | ‘chromosome, banding’ |
| timeper* | referring to time period or event for | ‘birth’, ‘pregnancy’ |
| | which a time period is associated | |
| timeunit* | referring to a unit of time | ‘hour’, ‘morning’ |
| unit* | unit of measurement other than time | ‘ampule’, ‘capsule’, ‘cc’ |
| vmodal* | certain auxillary verbs | ‘could’ ‘may’ |

The parser 12 operates to structure sentences according to pre-determined grammar rules 102. In some embodiments, the parser described in U.S. Pat. No. 6,182,029 to Friedman, the disclosure of which is incorporated by reference herein, can be used with certain modifications as the parser 12. The '029 patent describes a parser which includes five parsing modes, Modes 1 through 5, for parsing sentences or phrases The parsing modes are selected so as to parse a sentence or phrase structure using a grammar that includes one or more patterns of semantic and syntactic categories that are well-formed. If parsing fails, various error recovery techniques are employed in order to achieve at least a partial analysis of the phrase. These error recovery techniques include, for example, segmenting a sentence or phrase at pre-defined locations and processing the corresponding sentence portions or sub-phrases. Each recovery technique is likely to increase sensitivity but decrease specificity and precision. Sensitivity is the performance measure equal to the true positive information rate of the natural language system, i.e., the ratio of the amount of information actually extracted by the natural language processing system to the amount of information that should have been extracted. Specificity is the performance measure equal to the true negative information rate of the system, i.e., the ratio of the amount of information not extracted to the amount of information that should not have been extracted. In processing a report, the most specific mode is attempted first, and successive less specific modes are used only if needed.

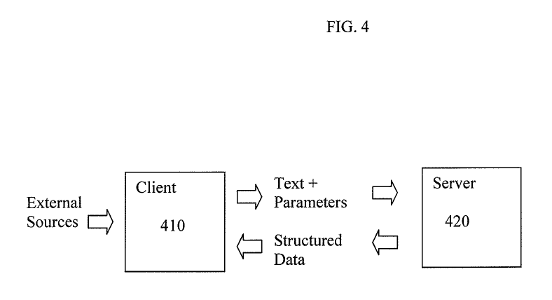

Referring next to FIG. 4, a client computer 410 and a server computer 420 which are used in some embodiments to implement the natural language processing program of FIG. 1 are shown. The client 410 received articles of other information from external sources such as the Internet, extranets, typed input or scanned documents which have been preprocessed via optical character recognition. The client 410 transmits text and any parameter information included in the received information to the server 420. In return, the server 420 can provide the client 410 with structured data which results from processing as described in connection with FIGS. 1-3 above.

The components of FIG. 1 can be software modules running on computer 420, a processor, or a network of interconnected processors and/or computers that communicate through TCP, UDP, or any other suitable protocol.

Conveniently, each module is software-implemented and stored in random-access memory of a suitable computer, e.g., a work-station computer. The software can be in the form of executable object code, obtained, e.g., by compiling from source code. Source code interpretation is not precluded. Source code can be in the form of sequence-controlled instructions as in Fortran, Pascal or “C”, for example. Alternatively, a rule-based system can be used such a Prolog, where suitable sequencing is chosen by the system at run-time.

The foregoing merely illustrates the principles of the invention. Various modifications and alterations to the described embodiments will be apparent to those skilled in the art in view of the teachings herein. For example, preprocessor 10, boundary identifier 11, parser 12, phrase recognizer 13, and encoder 14 can be hardware, such as firmware or VLSICs, that communicate via a suitable connection, such as one or more buses, with one or more memory devices storing lexicon 101, grammar rules 102, mappings 103 and codes 104. It will thus be appreciated that those skilled in the art will be able to devise numerous techniques which, although not explicitly described herein, embody the principles of the invention and are thus within the spirit and scope of the invention.

1. A method for extracting genotype-phenotype information from natural-language input text, comprising:
receiving natural-language input text which includes one or more genotype-phenotype relationships;
processing said natural-language input text to identify one or more biological terms therein;
associating each of said one or more biological terms within said natural-language input text with a lexical definition; and
parsing said one or more associated biological terms to replace at least one of said one or more of biological terms with a corresponding associated lexical definition to identify genotype-phenotype information from said from natural-language input text.

2. The method of claim 1, wherein said one or more biological terms comprise words and/or phrases.

3. The method of claim 2, wherein said processing further comprises extracting relevant textual information from said natural-language input text.

4. The method of claim 3, wherein said processing further comprises tagging one or more portions of said natural-language input text to be ignored.

5. The method of claim 1, wherein said processing further comprises:
identifying an abbreviated term defined in said natural-language input text by parenthetical information; and
locating a full form corresponding to said abbreviated term.

6. The method of claim 5, wherein said processing further comprises:
replacing said parenthetical information with a temporary entry; and
linking said full form to said abbreviated term.

7. The method of claim 6, wherein said linking further comprises using a mapping table to link said full form to said abbreviated term.

8. The method of claim 1, wherein said associating further comprises identifying a position of each of said one or more biological terms within said natural-language input text.

9. The method of claim 8, wherein said associating further comprises using a lexicon lookup to implement syntactical and semantic tagging of relevant information.

10. The method of claim 8, wherein said associating further comprises identifying one or more section boundaries within said natural-language input text.

11. The method of claim 8, wherein said associating further comprises identifying one or more sentence boundaries within said natural-language input text.

12. The method of claim 11, wherein said parsing further comprises using grammar rules to recognize syntactic and semantic patterns in one or more sentences determined by said identified sentence boundaries.

13. The method of claim 12, further comprising mapping said one or more associated biological terms into controlled vocabulary terms through a table of codes.

14. A system for extracting genotype-phenotype information from natural-language input text, comprising:
a processor receiving said natural-language input text and identifying one or more biological terms therein;
a boundary identifier, coupled to said processor and receiving said natural-language input text and identified biological terms therefrom, associating each of said one or more biological terms within said natural-language input text with at least one lexical definition; and
a parser, coupled to said boundary identifier and receiving said associated biological terms therefrom, determining at least one corresponding associated lexical definition to replace at least one of said one or more biological terms to identify genotype-phenotype information from said from natural-language input text.

15. The system of claim 14, further comprising a memory, coupled to said boundary identifier, storing a lexicon and wherein said boundary identifier associates each of said one or more biological terms within said natural-language input text with at least one lexical definition stored in said memory.

16. The system of claim 14, further comprising a phrase recognizer, coupled to said parser and receiving said determined corresponding associated lexical definitions therefrom, for replacing at least one of said one or more biological terms with said determined corresponding associated lexical definition.

17. The system of claim 16, further comprising a memory, coupled to said boundary identifier, storing one or more grammar rules, wherein said phrase recognizer is adapted for replacing at least one of said one or more biological terms with said determined corresponding associated lexical definition in accordance with one or more of said grammar rules.

18. The system of claim 14, further comprising a memory, coupled to said boundary identifier, storing a table of codes and an encoder, coupled to said parser, for mapping said one or more associated biological terms into controlled vocabulary terms through said table of codes.

19. The system of claim 14, further comprising an input for adding to or changing said at least one lexical definition.

20. A system for extracting genotype-phenotype information from natural-language input text, comprising:
processing means for receiving said natural-language input text and for identifying one or more biological terms therein;
boundary identification means, coupled to said processing means and receiving said natural-language input text and identified biological terms therefrom, for associating each of said one or more biological terms within said natural-language input text with at least one lexical definition; and
parsing means, coupled to said boundary identification means and receiving said associated biological terms therefrom, for determining at least one corresponding associated lexical definition to replace at least one of said one or more biological terms to identify genotype-phenotype information from said from natural-language input text.
